(19) United States
(12) Patent Application Publication
(10) Pub. No.: US 2025/0123474 A1
(43) Pub. Date: Apr. 17, 2025

(54) VARIABLE COHERENCE ILLUMINATION DEVICE AND OPTICAL MICROSCOPE SYSTEM INCLUDING THE SAME

(71) Applicant: KOREA BASIC SCIENCE INSTITUTE, Daejeon (KR)

(72) Inventors: Dong Uk Kim, Daejeon (KR); Ki Soo Chang, Daejeon (KR); I Jong Kim, Daejeon (KR); Chan Bae Jeong, Sejong-si (KR); Dongmok Kim, Daegu (KR); Ilkyu Han, Daejeon (KR)

(21) Appl. No.: 18/813,759

(22) Filed: Aug. 23, 2024

(30) Foreign Application Priority Data
Oct. 11, 2023 (KR) 10-2023-0135227
Dec. 1, 2023 (KR) 10-2023-0172664

(51) Int. Cl. G02B 21/08; G02B 21/26; G02B 26/06

(52) U.S. Cl. CPC G02B 21/08; G02B 21/26; G02B 26/06

(57) ABSTRACT

A variable coherence illumination device is disclosed. The variable coherence illumination device includes a light source generator configured to emit a beam and configured to control a wavelength of the beam, a focusing lens configured to focus the beam, a first diffuser on which a beam passing through the focusing lens is incident, a second diffuser facing the first diffuser and rotatable around a rotation axis of the second diffuser, in which a focusing region on which the beam passing through the first diffuser is focused by the focusing lens is formed on the second diffuser, in which the focusing region of the second diffuser is spaced apart from the rotation axis of the second diffuser.

### CROSS-REFERENCE TO RELATED APPLICATIONS

This application claims the benefit of Korean Patent Application No. 10-2023-0135227, filed on Oct. 11, 2023, and Korean Patent Application No. 10-2023-0172664, filed on Dec. 1, 2023, in the Korean Intellectual Property Office, the entire disclosure of which is incorporated herein by reference for all purposes.

### BACKGROUND

### 1. Field of the Invention

The present disclosure relates to a variable coherence illumination device and an optical microscope system including the same.

### 2. Description of the Related Art

Quantitative phase imaging (QPI) is technology that quantitatively measures a three-dimensional (3D) structure of a translucent sample in the field of life science or material science. Typically, it is possible to measure the thickness of a cell, the fluctuation of an intracellular refractive index, and the dry mass density of a cell. QPI should measure a local phase shift of a sample to extract information in a 3D structure, and for this purpose, a coherent light source such as a laser is used.

However, during QPI, as a coherent light source undergoes multiple reflections and unintended diffraction due to an optical element, or dust or scratches in an element, image quality is deteriorated by coherent artifacts, such as a speckle pattern (speckle noise) appearing in an image or emphasizing (coherent noise) the intensity around an edge. Deterioration of image quality causes phase fluctuation, making accurate phase shift measurement difficult. To solve this problem, there is a need for an illumination device that reduces coherent artifacts by adjusting coherence of a coherent light source or generating an uncorrelated speckle pattern.

### SUMMARY

According to an aspect, there is provided a variable coherence illumination device including a light source generator configured to emit a beam and configured to control a wavelength of the beam, a focusing lens configured to focus the beam, a first diffuser on which a beam passing through the focusing lens is incident, a second diffuser facing the first diffuser and rotatable around a rotation axis of the second diffuser, a collimating lens configured to convert a beam scattered passing through the second diffuser into a parallel beam, and a stage connected to the first diffuser and movable in a first direction, which is a direction that is parallel to the rotation axis of the second diffuser, in which a focusing region on which the beam passing through the first diffuser is focused by the focusing lens is formed on the second diffuser, in which the focusing region of the second diffuser is spaced apart from the rotation axis of the second diffuser.

A distance between the first diffuser and the second diffuser may be changed when the stage moves in the first direction.

A phase of the beam passing through the second diffuser may be changed when the stage moves in the first direction.

An area of the focusing region of the second diffuser may increase as a distance between the first diffuser and the second diffuser increases, based on the first direction.

The stage may be movable in a second direction crossing the first direction.

A distance in which the focusing region of the second diffuser is spaced apart from the rotation axis of the second diffuser may be changed when the stage moves in the second direction.

The variable coherence illumination device may further include a motor configured to provide power so that the second diffuser rotates.

According to another aspect, there is provided an optical microscope system including a variable coherence illumination device and a microscope portion connected to the variable coherence illumination device.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a perspective view schematically illustrating an optical microscope system including a variable coherence illumination device, according to an embodiment;

FIG. 2 is a diagram schematically illustrating the principle of reducing speckle noise;

FIGS. 3 and 4 are cross-sectional views schematically illustrating a change of spatial coherence according to a distance between a first diffuser and a second diffuser, according to an embodiment;

FIG. 5 is a table illustrating visibility according to a distance between a first diffuser and a second diffuser, according to an embodiment;

FIG. 6 is a table illustrating an average speckle contrast induced by a second diffuser according to the number of rotations of a motor, according to an embodiment;

FIG. 7 is a table illustrating visibility and an average speckle contrast according to a distance between a first diffuser and a second diffuser, according to an embodiment;

FIGS. 8 and 9 are diagrams schematically illustrating a focusing region of a second diffuser, according to an embodiment; and

FIGS. 10 and 11 are diagrams illustrating an image of a sample, according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a “first” component may be referred to as a “second” component, and similarly, the “second” component may be referred to as the “first” component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

The same name may be used to describe an element included in the embodiments described above and an element having a function in common. Unless disclosed to the contrary, the description of any one embodiment may be applied to other embodiments, and the specific description of the repeated configuration will be omitted.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like elements and a repeated description related thereto will be omitted.

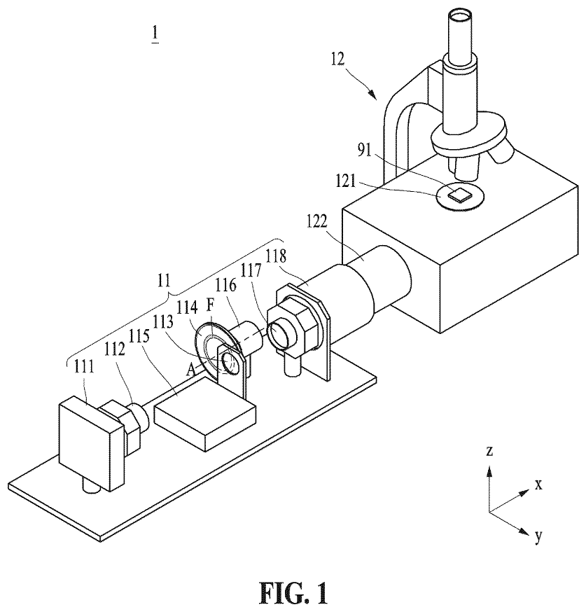

FIG. 1 is a perspective view schematically illustrating an optical microscope system including a variable coherence illumination device, according to an embodiment.

Referring to FIG. 1, an optical microscope system 1 according to an embodiment may include a microscope portion 12 connected to a variable coherence illumination device 11. The microscope portion 12 may include a sample holder 121 in which a sample 91 is disposed, and an illumination portion 122 connected to the variable coherence illumination device 11. The sample holder 121 may also be referred to as a sample stage. Here, the microscope portion 12 may be an optical microscope that may be used in various fields such as cell biology, anatomy, and clinical medicine. In an embodiment, the variable coherence illumination device 11 may be connected to the microscope portion 12 instead of an existing illumination device included in the microscope portion 12.

The amount of production of uncorrelated speckle patterns may increase by connecting the variable coherence illumination device 11 to the microscope portion 12. An image of the sample 91 with reduced coherent artifacts, such as speckle noise and coherent noise, may be obtained from the increased uncorrelated speckle patterns. Hereinafter, the variable coherence illumination device 11 is described in detail.

The variable coherence illumination device 11 may consecutively control spatial coherence of a light source by adjusting a distance between two diffusers (e.g., a first diffuser 113 and a second diffuser 114). Here, the spatial coherence represents a degree in which wavefronts of a beam are constant, which may represent a phase relationship between the wavefronts of the beam. The variable coherence illumination device 11 may generate a plurality of uncorrelated speckle patterns having different phases, and the spatial coherence may be reduced. The variable coherence illumination device 11 may include a light source generator 111, a focusing lens 112, the first diffuser 113, the second diffuser 114, a stage 115, a motor 116, a collimating lens 117, and a microscope connection portion 118.

The light source generator 111 may emit a beam and may control a wavelength of the beam. Here, the beam may be formed from a coherent light source like a laser. The focusing lens 112 may focus the beam emitted from the light source generator 111. Light passing through the focusing lens 112 may be incident on the first diffuser 113 and then focused on the second diffuser 114.

The first diffuser 113 and the second diffuser 114 may face each other. In an embodiment, the first diffuser 113 may be connected to the stage 115. As the stage 115 moves in first and second directions, the first diffuser 113 may move in the first and second directions with respect to the second diffuser 114. Here, the first direction may be a front-rear direction that is parallel to an x-axis, and the second direction may be a left-right direction crossing the first direction and parallel to a y-axis.

In an embodiment, the second diffuser 114 may rotate around a rotation axis A. For example, a cross-section of the second diffuser 114 may be circular, and the rotation axis A may pass through the center of the second diffuser 114. The rotation axis A of the second diffuser 114 may be parallel to the first direction. In an embodiment, the second diffuser 114 may be connected to the motor 116 that generates power. The motor 116 may provide power to the second diffuser 114, and the second diffuser 114 may rotate around the rotation axis A.

In an embodiment, a focusing region F that generates uncorrelated speckle patterns may be formed on the second diffuser 114. The focusing region F may be a region on which a beam passing through the first diffuser 113 is focused by the focusing lens 112. Based on the first direction, the center of the first diffuser 113 may not coincide with the center of the second diffuser 114. For example, the center of the first diffuser 113 may be located on the right side of the center of the second diffuser 114. From this structure, the beam passing through the first diffuser 113 may be focused on a location that is spaced apart from the rotation axis A of the second diffuser 114. As the second diffuser 114 rotates around the rotation axis A, the focusing region F may be formed in a ring shape centered on the rotation axis A of the second diffuser 114.

The collimating lens 117 may convert a beam scattered passing through the second diffuser 114 into a parallel beam. The microscope connection portion 118 may be disposed between the collimating lens 117 and the microscope portion 12. The microscope connection portion 118 may have a hollow cylindrical shape, for example. The parallel beam from conversion by the collimating lens 117 may pass through the microscope connection portion 118 and may reach the illumination portion 122 of the microscope portion 12. Thereafter, the parallel beam may be reflected by the sample 91, and the image of the sample 91 may be observed by a user.

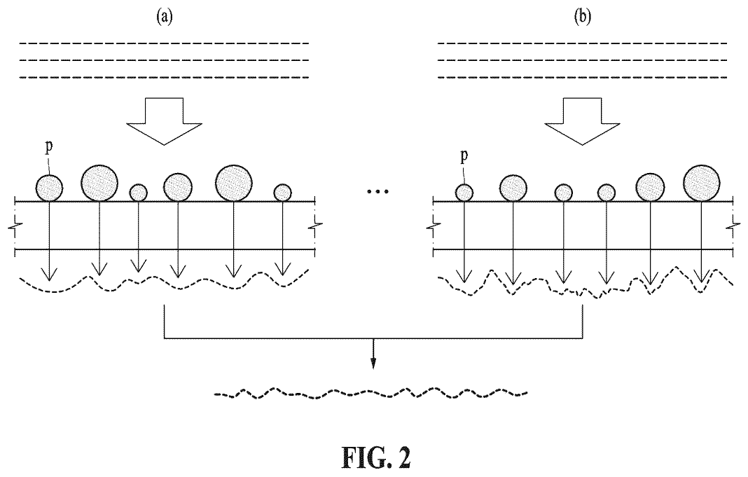

FIG. 2 is a diagram schematically illustrating the principle of reducing speckle noise.

In FIG. 2, particles p may be the particles p present on a surface of a second diffuser (e.g., the second diffuser 114 in FIG. 1) facing a first diffuser (e.g., the first diffuser 113 in FIG. 1). The plurality of particles p may be irregularly present on the surface of the second diffuser and may have different shapes, respectively.

As shown in (a) FIG. 2, in a state in which the second diffuser is stationary without rotating (hereinafter, referred to as a ‘first state’), a region of the second diffuser to which a beam reaches may be fixed, and the number of uncorrelated speckle patterns generated by the particles p may be relatively small. An amount by which the uncorrelated speckle patterns overlap each other on an image of a sample (e.g., the sample 91 in FIG. 1) and are offset may be relatively small. A deviation of a phase measured along a horizontal line of the image of the sample may be large.

In the first state, the second diffuser may reach a state by rotating for an arbitrary time (hereinafter, referred to as a ‘second state’), as shown in (b) of FIG. 2. While the second diffuser rotates from the first state to the second state, a region of the second diffuser to which the beam reaches may change over time, and the number of uncorrelated speckle patterns generated by the particles p may be relatively large. In this case, an amount by which the uncorrelated speckle patterns overlap each other on the image of the sample and are offset may be relatively large. The deviation of the phase measured along the horizontal line of the image of the sample may be small. That is, as the number of uncorrelated speckle patterns to be generated increases, coherent artifacts may decrease. In an embodiment, a user may increase the amount of production of uncorrelated speckle patterns by controlling a location of the first diffuser with respect to the second diffuser of a variable coherence illumination device (e.g., the variable coherence illumination device 11 in FIG. 1) and the rotation speed of the second diffuser.

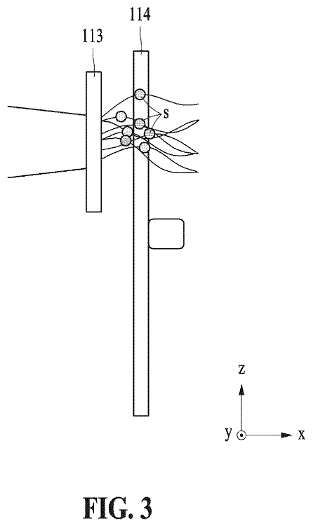

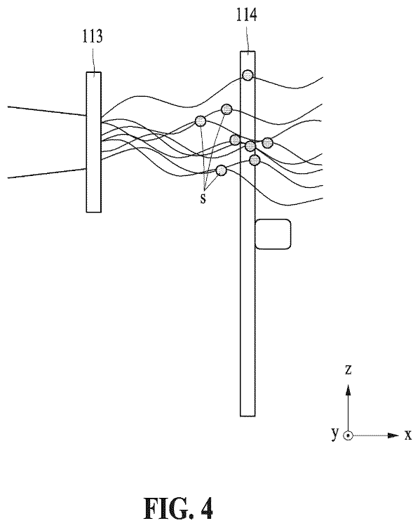

FIGS. 3 and 4 are cross-sectional views schematically illustrating a change of spatial coherence according to a distance between a first diffuser and a second diffuser, according to an embodiment.

Referring to FIGS. 3 and 4, a variable coherence illumination device (e.g., the variable coherence illumination device 11 in FIG. 1) according to an embodiment may control an optical-path difference of the beam scattered by the first diffuser 113 and spatial coherence by controlling a distance between the first diffuser 113 and the second diffuser 114. Here, the distance between the first diffuser 113 and the second diffuser 114 may be a distance measured based on a first direction.

As shown in FIG. 3, each spot s displayed on beams may represent positions with the same wavefront after being emitted from a light source generator (e.g., the light source generator 111 in FIG. 1) at the certain time and then passing through the first diffuser 113. In a state in which a degree of dispersion of each spot s is relatively low, the wavefront of the beam scattered by the second diffuser 114 may be relatively uniform. In this case, the spatial coherence may be relatively high.

As shown in FIG. 4, as a stage (e.g., the stage 115 in FIG. 1) moves, a distance between the first diffuser 113 and the second diffuser 114 may become relatively long. In this case, in a state in which a degree of dispersion of each spot s is relatively high, the wavefront of the beam scattered by the second diffuser 114 may be relatively non-uniform. The phase of the beams passing through the second diffuser 114 may change relatively significantly, and the spatial coherence may be relatively low. An area of a focusing region of the second diffuser 114 may also relatively increase. Due to the non-uniformity of the wavefront of the beam and the change in an area of the focusing region, the amount of change in visibility may be maximized. Since the distance between the first diffuser 113 and the second diffuser 114 is consecutively controlled, the spatial coherence corresponding thereto may also be consecutively controlled. Considering the rotation speed of the second diffuser 114 and the surface density of the second diffuser 114, optimal spatial coherence may be determined so that coherent artifacts are minimized.

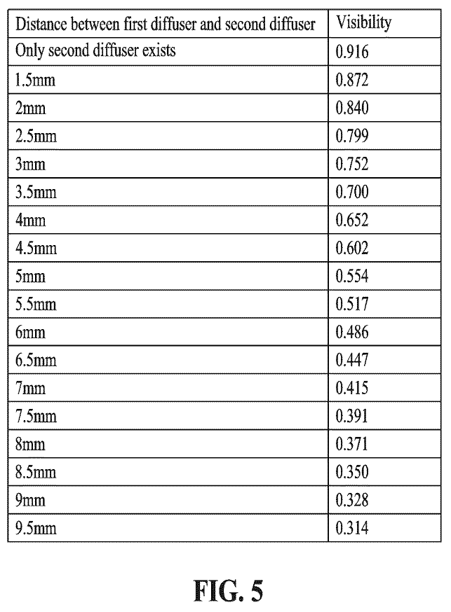

FIG. 5 is a table illustrating visibility according to a distance between a first diffuser and a second diffuser, according to an embodiment.

Referring to FIG. 5, a variable coherence illumination device (e.g., the variable coherence illumination device 11 in FIG. 1) according to an embodiment may consecutively control a range of visibility and may identify a control range of coherence of the beam by controlling a distance between a first diffuser (e.g., the first diffuser 113 in FIG. 1) and a second diffuser (e.g., the second diffuser 114 in FIG. 1).

In an embodiment, a double slit (not shown) and a camera portion (not shown) may be used to evaluate the performance of the variable coherence illumination device. After a microscope connection portion of the variable coherence illumination device is separated from an illumination portion of a microscope portion, the double slit and the camera portion may be disposed in order in a path of the beam traveling from the microscope connection portion.

In an embodiment, the beam passing through the double slit may be detected by the camera portion. An intensity profile of the beam may be obtained by selecting an arbitrary region from a diffraction image of the beam. Gaussian fitting may be performed on the obtained intensity profile using a Gaussian function. In a graph on which Gaussian fitting is performed, when maximum intensity of the beams is Iₘₐₓ and the minimum intensity is Iₘᵢₙ, visibility V may be calculated from Equation 1 below.

$$V = \frac{{I}_{max} - {I}_{min}}{{I}_{max} + {I}_{min}} \qquad [ Equation 1 ]$$

In an embodiment, the variable coherence illumination device may include a light source generator (e.g., the light source generator 111 in FIG. 1) including a laser diode of 635 nanometers (nm), a focusing lens (e.g., the focusing lens 112 in FIG. 1) with a focal length of 100 millimeters (mm) and a diameter of 1″, a first diffuser with a diffuse angle of 1 degree) (°) and a diameter of 1″, a second diffuser with a diffuse angle of 10° and a diameter of 2″, a collimating lens (e.g., the collimating lens 117 in FIG. 1) with a focal length of 50 mm and a diameter of 1″, a motor (e.g., the motor 116 in FIG. 1) including a brushless direct current (DC) servomotor with a rotation speed of 1,000 revolutions per minute (rpm), and a stage (e.g., the stage 115 in FIG. 1) including a micrometer moving stage with a moving distance of 12.7 mm.

Under the above conditions, the visibility may be measured to be 0.872 when the distance between the first diffuser and the second diffuser is 1.5 mm. It may be seen that the visibility decreases as the distance between the first diffuser and second diffuser increases, and the visibility is measured to be 0.314 when the distance between the first diffuser and second diffuser is 9.5 mm. In this case, the visibility may be consecutively controlled in a range of 0.314 to 0.872, and the spatial coherence of the beam may also be consecutively controlled.

Furthermore, it should be noted that a value of the visibility may be measured differently when the conditions for configuring the variable coherence illumination device change, or an external environment for measuring the visibility changes. In addition, it should be noted that an error may exist between values of the visibility obtained through repeated measurements.

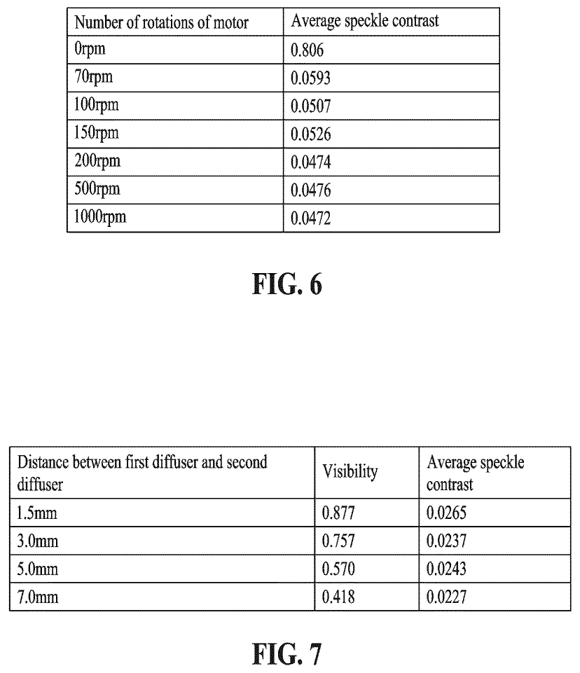

FIG. 6 is a table illustrating an average speckle contrast induced by a second diffuser according to the number of rotations of a motor, according to an embodiment.

Referring to FIG. 6, a user may identify a decrease in speckle noise through a speckle contrast. Unlike a case of measuring visibility of a variable coherence illumination device (e.g., the variable coherence illumination device 11 in FIG. 1), in the case of measuring the speckle contrast, a double slit may be excluded and only a camera portion may be used. That is, the beam traveling from a microscope connection portion (e.g., the microscope connection portion 118 in FIG. 1) of the variable coherence illumination device may reach the camera portion without passing through the double slit.

In an embodiment, the camera portion may provide an intensity distribution image of the beam generated by the variable coherence illumination device. Using Equations 2 and 3 below, a speckle contrast C may be calculated from an average brightness value x̅ for an arbitrary region of the intensity distribution image, the maximum brightness value x in an arbitrary region, the number of pixels n=640×640 in a corresponding region, and a standard deviation σ of brightness.

$$σ = \sqrt{\frac{\sum {( x - \overline{x} )}^{2}}{n - 1}} \qquad [ Equation 2 ]$$

$$C = σ / \overline{x} \qquad [ Equation 3 ]$$

In an embodiment, the variable coherence illumination device may not include a first diffuser (e.g., the first diffuser 113 in FIG. 1) and may include a light source generator (e.g., the light source generator 111 in FIG. 1) including a laser diode of 635 nm, a focusing lens (e.g., the focusing lens 112 in FIG. 1) with a focal length of 100 mm and a diameter of 1″, a second diffuser (e.g., the second diffuser 114 in FIG. 1) with a diffuse angle of 10° and a diameter of 2″, a collimating lens (e.g., the collimating lens 117 in FIG. 1) with a focal length of 50 mm and a diameter of 1″, and a motor (e.g., the motor 116 in FIG. 1) including a brushless DC servomotor. Under the above conditions, an average speckle contrast C_{avg} may be measured to be 0.806 when the motor does not provide power. Here, an average speckle contrast may be an average value of the speckle contrast measurement repeated 10 times. It may be seen that the average speckle contrast decreases as the rotation speed of the motor increases, and the average speckle contrast is measured to be 0.0474 when the rotation speed of the motor is 200 rpm. It may be seen that the average speckle contrast does not change significantly when the rotation speed of the motor is greater than or equal to 200 rpm.

Furthermore, it should be noted that a value of the average speckle contrast may be measured differently when the conditions for configuring the variable coherence illumination device change, or an external environment for measuring the average speckle contrast changes.

FIG. 7 is a table illustrating visibility and an average speckle contrast according to a distance between a first diffuser and a second diffuser, according to an embodiment.

In an embodiment, a variable coherence illumination device (e.g., the variable coherence illumination device 11 in FIG. 1) may include a light source generator (e.g., the light source generator 111 in FIG. 1) including a laser diode of 635 nm, a focusing lens (e.g., the focusing lens 112 in FIG. 1) with a focal length of 100 mm and a diameter of 1″, a first diffuser (e.g., the first diffuser 113 in FIG. 1) with a diffuse angle of 1° and a diameter of 1″, a second diffuser (e.g., the second diffuser 114 in FIG. 1) with a diffuse angle of 10° and a diameter of 2″, a collimating lens (e.g., the collimating lens 117 in FIG. 1) with a focal length of 50 mm and a diameter of 1″, and a motor (e.g., the motor 116 in FIG. 1) including a brushless DC servomotor with a rotation speed of 1,000 rpm. Under the above conditions, the visibility and average speckle contrast may be measured according to a distance between the first diffuser and the second diffuser.

In an embodiment, as shown in the table of FIG. 5, it may be seen again that the visibility decreases as the distance between the diffuser and the second diffuser increases. Compared to the average speckle contrast (see FIG. 6) measured using the variable coherence illumination device including the second diffuser after the first diffuser is removed, it may be seen that when the variable coherence illumination device includes both the first diffuser and the second diffuser, the average speckle contrast decreases by about two times and the speckle noise reduction is improved by about two times accordingly.

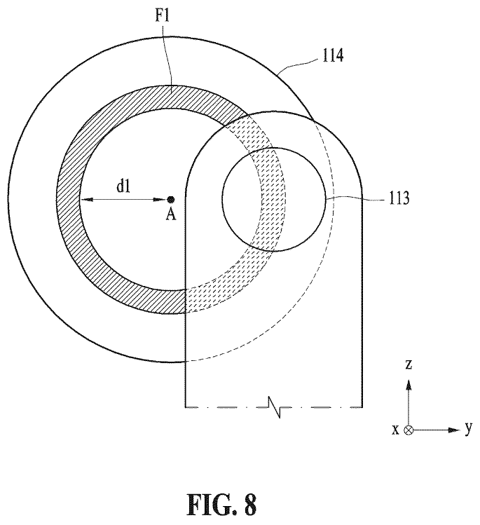

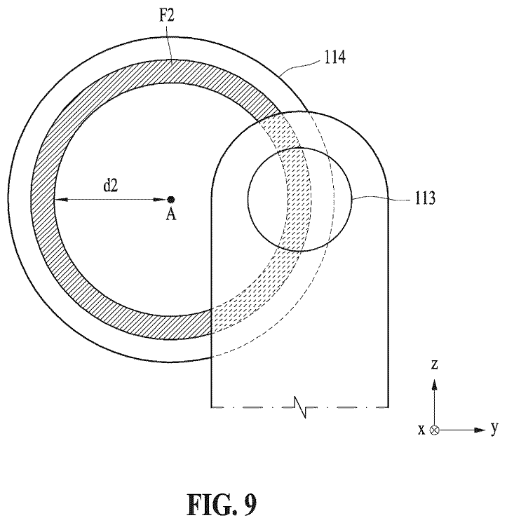

FIGS. 8 and 9 are diagrams schematically illustrating a focusing region of a second diffuser, according to an embodiment.

Referring to FIGS. 8 and 9, according to an embodiment, a distance in which a focusing region (e.g., the focusing region F in FIG. 1) is spaced apart from the rotation axis A of the second diffuser 114 may vary. As shown in FIG. 8, in an embodiment, the center of the first diffuser 113 may be located on the right side based on the center of the second diffuser 114. Here, the right side may be a +y direction. In this case, a focusing region F1 that is spaced apart from the rotation axis A of the second diffuser 114 by a distance d1 may be formed on the second diffuser 114.

As shown in FIG. 9, as a stage (e.g., the stage 115 in FIG. 1) moves to the right side, the center of the first diffuser 113 may move further away from the center of the second diffuser 114. In this case, a focusing region F2 that is spaced apart from the rotation axis A of the second diffuser 114 by a distance d2 may be formed on the second diffuser 114. Here, the distance d2 may be a value that is greater than the distance d1. As a distance in which a focusing region is away from the rotation axis A of the second diffuser 114 increases, the diameter of the focusing region may increase and the amount of production of uncorrelated speckle patterns may increase.

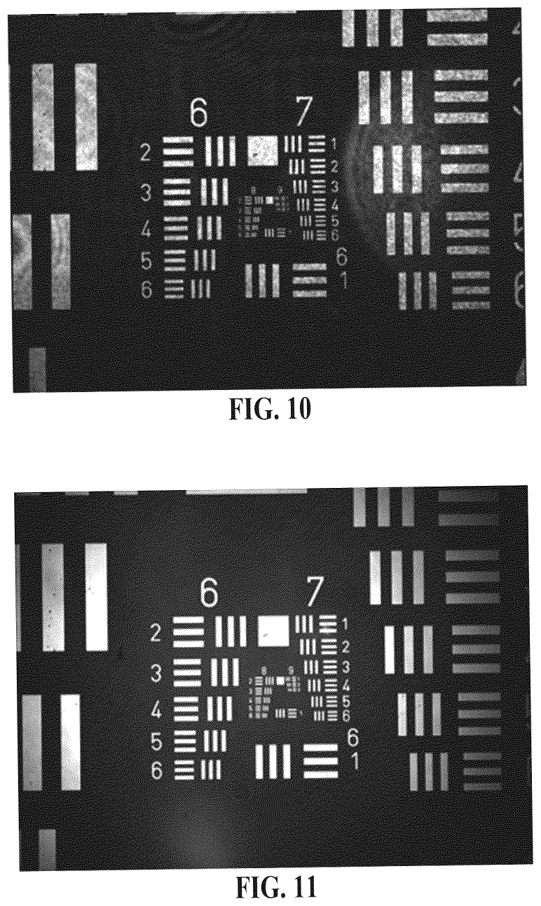

FIGS. 10 and 11 are diagrams illustrating an image of a sample, according to an embodiment.

FIG. 10 shows a sample (e.g., the sample 91 in FIG. 1) illuminated on an optical microscope system that includes a microscope portion (e.g., the microscope portion 12 in FIG. 1) connected to an existing illumination device instead of a variable coherence illumination device (e.g., the variable coherence illumination device 11 in FIG. 1). It may be seen that speckle noise appears in the image of the sample. Here, a Nikon Eclipse Ti model is used as the microscope portion, and the image of the sample may be obtained by directly illuminating the sample with a laser diode of 635 nm.

FIG. 11 shows a sample illuminated after a variable coherence illumination device is connected to an illumination portion of a microscope portion that uses a Nikon Eclipse Ti model. It may be seen that speckle noise is reduced in an image of a sample. Here, the variable coherence illumination device may include a light source generator (e.g., the light source generator 111 in FIG. 1) including a laser diode of 635 nm, a focusing lens (e.g., the focusing lens 112 in FIG. 1) with a focal length of 100 mm and a diameter of 1″, a first diffuser (e.g., the first diffuser 113 in FIG. 1) with a diffuse angle of 1° and a diameter of 1″, a second diffuser (e.g., the second diffuser 114 in FIG. 1) with a diffuse angle of 10° and a diameter of 2″, a collimating lens (e.g., the collimating lens 117 in FIG. 1) with a focal length of 50 mm and a diameter of 1″, and a motor (e.g., the motor 116 in FIG. 1) including a brushless DC servomotor with a rotation speed of 1,000 rpm.

Although the variable coherence illumination device is described as being included in an optical microscope system (e.g., the optical microscope system 1 in FIG. 1), the variable coherence illumination device may be used as a light source generator in any system. For example, the variable coherence illumination device may be used in a beam projector system that uses a laser.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. A variable coherence illumination device comprising:
a light source generator configured to emit a beam and configured to control a wavelength of the beam;
a focusing lens configured to focus the beam;
a first diffuser on which a beam passing through the focusing lens is incident;
a second diffuser facing the first diffuser and rotatable around a rotation axis of the second diffuser;
a collimating lens configured to convert a beam scattered passing through the second diffuser into a parallel beam; and
a stage connected to the first diffuser and movable in a first direction, which is a direction that is parallel to the rotation axis of the second diffuser,
wherein a focusing region on which the beam passing through the first diffuser is focused by the focusing lens is formed on the second diffuser, wherein the focusing region of the second diffuser is spaced apart from the rotation axis of the second diffuser.

2. The variable coherence illumination device of claim 1, wherein a distance between the first diffuser and the second diffuser is changed when the stage moves in the first direction.

3. The variable coherence illumination device of claim 1, wherein a phase of the beam passing through the second diffuser is changed when the stage moves in the first direction.

4. The variable coherence illumination device of claim 1, wherein an area of the focusing region of the second diffuser increases as a distance between the first diffuser and the second diffuser increases, based on the first direction.

5. The variable coherence illumination device of claim 1, wherein the stage is movable in a second direction crossing the first direction.

6. The variable coherence illumination device of claim 5, wherein a distance in which the focusing region of the second diffuser is spaced apart from the rotation axis of the second diffuser is changed when the stage moves in the second direction.

7. The variable coherence illumination device of claim 1, further comprising:
a motor configured to provide power so that the second diffuser rotates.

8. An optical microscope system comprising:
the variable coherence illumination device according to claim 1; and
a microscope portion connected to the variable coherence illumination device.
